(19) United States
(12) Patent Application Publication
(10) Pub. No.: US 2026/0167123 A1
(43) Pub. Date: Jun. 18, 2026

(54) SURFACE MATERIAL AND INTERIOR MATERIAL

(71) Applicants: HONDA MOTOR CO., LTD., Tokyo (JP); NIHON PLAST CO., LTD., Fujinomiya-shi (JP)

(72) Inventors: Yasushi Fujikura, Tokyo (JP); Shin Matsumoto, Tokyo (JP); Takaaki Seki, Shizuoka (JP); Kenichi Kamio, Shizuoka (JP)

(21) Appl. No.: 19/414,860

(22) Filed: Dec. 10, 2025

(30) Foreign Application Priority Data
Dec. 16, 2024 (JP) 2024-220203

(51) Int. Cl. B60R 13/02; B29C 45/00; B29L 31/30

(52) U.S. Cl. CPC B60R 13/02; B29C 45/0053; B29L 2031/3005

(57) ABSTRACT

Provided are: a surface material that is easy to sew and has excellent appearance; and an interior material including the same. A surface material includes: a first surface portion; and a second surface portion that is continuous with the first surface portion through a continuous portion and where a back surface side is formed stepwise on a front surface side with respect to the first surface portion. The second surface portion includes a sewing-scheduled portion to be sewn with a sewing thread. The continuous portion is provided with an expansion-assisting portion that allows the continuous portion to be expandable from the back surface side, at a position along the sewing-scheduled portion on the back surface side.

### CROSS REFERENCE TO RELATED APPLICATIONS

The disclosure of Japanese Patent Application No. 2024-220203 filed on Dec. 16, 2024 including the specification, drawings and abstract is incorporated herein by reference in its entirety.

### TECHNICAL FIELD

The present invention relates to a surface material where a back surface side is formed stepwise and an interior material including the same.

### BACKGROUND ART

In the related art, it is known that, in a surface material that is formed of a synthetic resin by injection molding, a parting line (PL) is set in a concave groove such that the parting line is inconspicuous during molding, and this portion is sewn after molding such that the parting line is finally inconspicuous (for example, refer to PTL 1).

### CITATION LIST

### Patent Literature

### PTL 1

Japanese Patent Application Laid-Open No. 2013-139103

### SUMMARY OF INVENTION

### Technical Problem

In the surface material formed of a synthetic resin, various shapes can be expressed on a front surface, but as the shape is complicated, there is a case where a shape of a back surface side may not be a flat shape. In a case where the back surface side is not flat, for example, when the surface material is sewn by means of, for example, a sewing machine, it is difficult to hold down the surface material in a flat shape. Therefore, a manufacturing step is complicated to prevent strain and a tension defect from occurring in the sewn portion.

The present invention has been in consideration of the above-described points, and an object thereof is to provide: a surface material that is easy to sew and has excellent appearance; and an interior material including the same.

### Solution to Problem

A surface material according to an aspect of the present invention includes: a first surface portion; and a second surface portion that is continuous with the first surface portion through a continuous portion and where a back surface side is formed stepwise on a front surface side with respect to the first surface portion, in which the second surface portion includes a sewing-scheduled portion to be sewn with a sewing thread, and the continuous portion is provided with an expansion-assisting portion that allows the continuous portion to be expandable from the back surface side, at a position along the sewing-scheduled portion on the back surface side.

### Advantageous Effects of Invention

According to the present invention, it is possible to provide: a surface material that is easy to sew and has excellent appearance; and an interior material including the same.

### BRIEF DESCRIPTION OF DRAWINGS

FIG. 1A is a front view showing a surface material according to Embodiment 1 of the present invention, and FIG. 1B is a cross-sectional view showing the surface material that has been sewn;

FIG. 2 is a perspective view schematically showing a part of a sewing apparatus for sewing the surface material;

FIG. 3 is a perspective view schematically showing a step of sewing the surface material;

FIG. 4 is a perspective view showing an example of an interior material including the surface material;

FIG. 5 is a cross-sectional view schematically showing Reference Example of the surface material;

FIG. 6 is a front view showing a surface material according to Embodiment 2 of the present invention;

FIG. 7 is a front view showing a surface material according to Embodiment 3 of the present invention;

FIG. 8 is a front view showing a surface material according to Embodiment 4 of the present invention;

FIG. 9 is a front view showing a surface material according to Embodiment 5 of the present invention;

FIG. 10 is a front view showing a surface material according to Embodiment 6 of the present invention;

FIG. 11 is a front view showing a surface material according to Embodiment 7 of the present invention;

FIG. 12 is a front view showing a surface material according to Embodiment 8 of the present invention; and

FIG. 13 is a perspective cross-sectional view showing a part of the surface material.

### DESCRIPTION OF EMBODIMENTS

Hereinafter, Embodiment 1 of the present invention will be described with reference to the drawings.

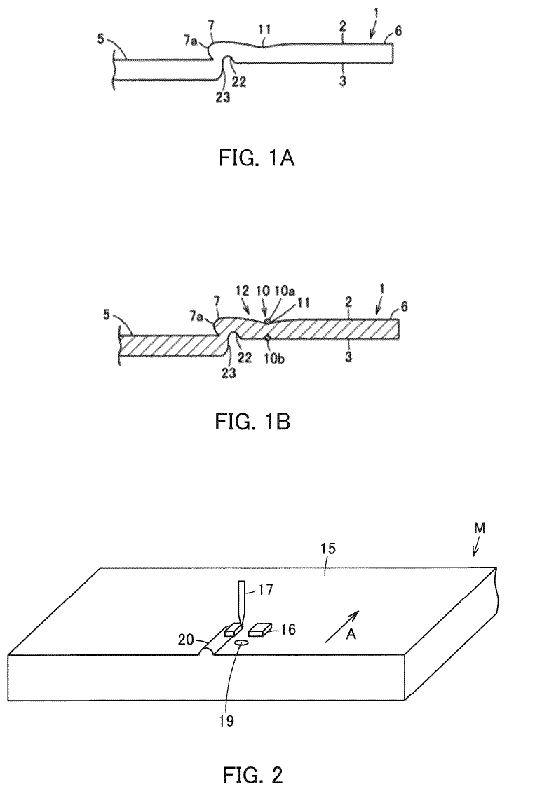

In FIGS. 1A and 1B, 1 represents a surface material. The surface material 1 is used to cover at least a part of a front surface as a target to be covered. Examples of the surface material 1 include leather that is formed of a synthetic resin (synthetic leather). The surface material 1 has a flexible sheet shape and is formed by, for example, injection molding. The surface material 1 includes: a design surface 2 that is a front surface positioned on the outer side; and a counterface surface 3 that is a back surface positioned on the target side to be covered. An external shape of the surface material 1 has a quadrangular shape in the drawing, but can be appropriately set according to the target to be covered.

The surface material 1 according to the present embodiment integrally includes a first surface portion 5 and a second surface portion 6. The first surface portion 5 has, for example, a constant or substantially constant thickness, and extends in a planar shape.

The second surface portion 6 basically has a thickness that is equal to or substantially equal to that of the first surface portion 5, and extends in a planar shape. The second surface portion 6 is continuous with the first surface portion 5 through a continuous portion 7. The continuous portion 7 has a curved shape where the design surface 2 protrudes to the first surface portion 5 side in an arc shape. That is, the continuous portion 7 has a protrusion shape that expands to protrude to the first surface portion 5 side and is continuous with the design surface 2 of the first surface portion 5 at a position on a side of the second surface portion 6 further than a tip 7a of the expansion. That is, the continuous portion 7 is continuous with the design surface 2 of the first surface portion 5 at a position where a front surface thereof is folded to be curved to the second surface portion 6 side. In a portion including the continuous portion 7 and a peripheral portion thereof, as shown in Reference Example of FIG. 5, for example, a terminal portion of one surface piece 8a formed of genuine leather (natural leather) is folded to overlap, for example, a terminal portion of another surface piece 8b formed of genuine leather (natural leather), and a design similar to a connection portion where the terminal portions are connected to each other is exhibited. As a result, an impression is given as if the surface material 1 shown in FIG. 1A consists of a plurality of surface pieces, which improves the design.

In addition, in the second surface portion 6, in order to improve the design, a sewing-scheduled portion 11 to be sewn with a sewing thread 10 is set. By sewing the sewing-scheduled portion 11 with the sewing thread 10, a sewn portion 12 is formed. In the surface material 1, a portion other than the sewing-scheduled portion 11 is an ordinary portion that is a so-called non-sewn portion not to be sewn.

In the present embodiment, the sewing thread 10 includes: an upper thread 10a of which a part is positioned on the design surface 2 to form a stitch; and a lower thread 10b that is entangled with the upper thread 10a to be positioned on the counterface surface 3 side and not to be exposed to the design surface 2 side. In the example shown in the drawing, the upper thread 10a is disposed in a wave-like shape to be entangled with the upper thread 10a on the back side from the design surface 2 through a needle hole formed in the sewing-scheduled portion 11, and the lower thread 10b is disposed linearly on the counterface surface 3 side. The needle hole may be formed by a sewing needle penetrating the surface material 1 at the position of the sewing-scheduled portion 11 in a thickness direction during sewing, and may be previously formed in the sewing-scheduled portion 11 before sewing.

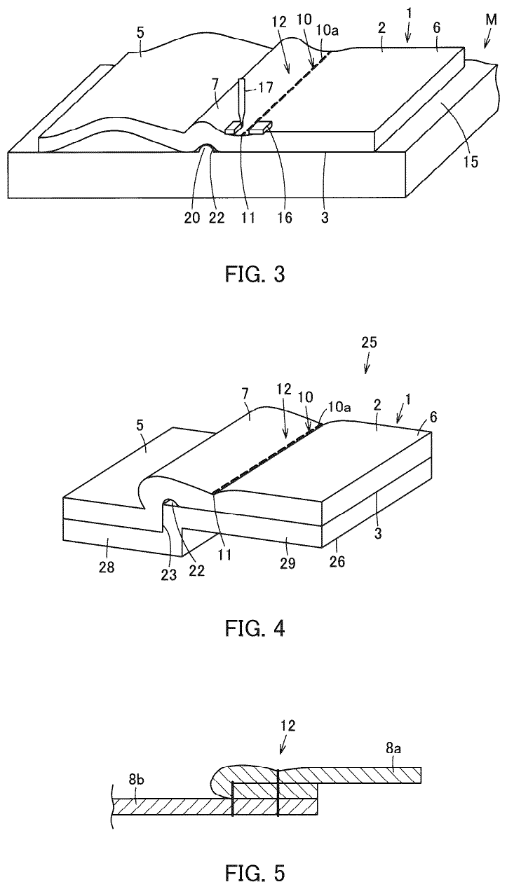

The sewing-scheduled portion 11 is formed such that the design surface 2 side is depressed in the thickness direction from the peripheral portion thereof in the second surface portion 6. The sewing-scheduled portion 11 is formed along a predetermined line. In the drawing, an example where the sewing-scheduled portion 11 is formed along a straight line is shown. However, the present invention is not limited to this example, and the sewing-scheduled portion 11 may be formed along a curved line. The sewing-scheduled portion 11 is at a position that is at a constant or substantially constant distance from and parallel to the tip 7a of the continuous portion 7 forming the terminal portion of the second surface portion 6 that is an end portion on the first surface portion 5 side. “Parallel” is generally an expression that defines a relationship between straight lines. However, the present embodiment is not limited to the relationship between straight lines, and a state where portions are positioned at a constant or substantially constant distance from each other along a predetermined line will be referred to as “parallel”. In this example, as shown in FIG. 3, a so-called single-stitched sewn portion 12 is formed to have a design where stitches formed in the sewing-scheduled portion 11 by the upper thread 10a of the sewing thread 10 are parallel to the tip of the continuous portion 7.

In the second surface portion 6, the counterface surface 3 side is formed stepwise on the design surface 2 side, that is, the upper side in the drawing with respect to the counterface surface 3 side of the first surface portion 5. For example, in the present embodiment, the counterface surface 3 of the second surface portion 6 is at a position that is flush with or substantially flush with the design surface 2 of the first surface portion 5.

In the present embodiment, the sewn portion 12 is formed by a sewing machine M that is a sewing apparatus shown in FIG. 2. The sewing machine M includes a support surface 15 that is a needle plate portion supporting the surface material 1, a holder 16 that holds a part of the surface material 1 against the support surface 15, and a sewing needle 17 that vertically moves relative to the support surface 15. A shuttle portion where a bobbin around which the lower thread 10b (shown in FIG. 1B) of the sewing thread 10 is wound is formed below the support surface 15, and a hole 19 where a tip portion of a sewing needle 17 is inserted and removed into and from the shuttle portion according to the vertical movement of the sewing needle 17 is formed in the support surface 15. The holder 16 has a shape in which the tip side in a feeding direction (indicated by arrow A) of the surface material 1 (shown in FIG. 1A) is branched into two parts, and the sewing needle 17 vertically moves at a position between the tips of the holder 16. In the support surface 15, a convex portion 20 for positioning and guiding the surface material 1 (shown in FIG. 1A) during sewing may be formed. The convex portion 20 protrudes upward from the support surface 15. The convex portion 20 is linearly positioned from the front to the rear in the feeding direction with respect to the holder 16 and the sewing needle 17 on the support surface 15.

As shown in FIG. 3, in a state where the surface material 1 is placed on the support surface 15 such that the counterface surface 3 faces downward and where the sewing-scheduled portion 11 is positioned between the tips of the holder 16 such that the second surface portion 6 of the surface material 1 is held from the design surface 2 side by the holder 16, the sewing needle 17 is caused to penetrate the sewing-scheduled portion 11 while feeding the surface material 1 along the sewing-scheduled portion 11, and the upper thread 10a passing through the tip portion of the sewing needle 17 is entangled with the lower thread 10b (shown in FIG. 1B) wound around the bobbin for sewing.

At this time, in the surface material 1, the flexibility of the continuous portion 7 is lower than that of the other portions due to the steps in the continuous portion 7 between the second surface portion 6 and the first surface portion 5. Therefore, the counterface surface 3 of the second surface portion 6 swells to float from the support surface 15, the holding by the holder 16 does not function well, and there is a concern that sewing does not progress well.

Therefore, in the surface material 1 of the present embodiment, as shown in FIG. 1A, an expansion-assisting portion 22 that allows the continuous portion 7 to be expandable from the counterface surface 3 side is formed in the continuous portion 7. The expansion-assisting portion 22 is provided to improve the flexibility of the continuous portion 7 and to allow the holder 16 of the sewing machine M to stably hold the second surface portion 6 down in a planar shape against the support surface 15 as shown in FIG. 3 irrespective of the steps of the counterface surface 3 between the first surface portion 5 and the second surface portion 6. As shown in FIG. 1A, the expansion-assisting portion 22 is formed opposite to the design surface 2 of the continuous portion 7. In the present embodiment, the expansion-assisting portion 22 is formed at a position of a corner portion where the counterface surface 3 of the second surface portion 6 and an end surface 23 of the first surface portion 5 on the second surface portion 6 side are continuous with each other. The expansion-assisting portion 22 is a concave portion (notch portion) accompanied by hollowing or is a slit that is cut by, for example, an edged tool. The expansion-assisting portion 22 is formed to be continuous with a position along the sewing-scheduled portion 11 in the continuous portion 7. In the present embodiment, the expansion-assisting portion 22 is continuous and parallel to the sewing-scheduled portion 11. The expansion-assisting portion 22 corresponds to a position across at least the entirety of the sewing-scheduled portion 11.

In the present embodiment, the expansion-assisting portion 22 is a notch portion that is formed in a semi-cylindrical surface shape where the design surface 2 side is convex. In the example shown in the drawing, the expansion-assisting portion 22 is positioned on the second surface portion 6 side further than the end surface 23 of the first surface portion 5 not to go into the first surface portion 5 side. In addition, an inner surface of the expansion-assisting portion 22 has a curved shape corresponding to the curved shape of the front surface of the continuous portion 7.

Therefore, as shown in FIG. 3, when the surface material 1 is placed on the support surface 15 of the sewing machine M and the second surface portion 6 is held against the support surface 15 from the design surface 2 side by the holder 16, the counterface surface 3 of the second surface portion 6 comes into firm contact with the support surface 15 particularly at the position of the sewing-scheduled portion 11. Accordingly, the sewing on the sewing-scheduled portion 11 by the sewing machine M is easy, strain and a variation in tension are not likely to occur in the formed sewn portion 12, and the sewing-scheduled portion 11 is not substantially deformed during sewing. Therefore, even when the surface material 1 returns to the original form after sewing, for example, the effect of unexpected tension on the sewn portion 12 is small, and the surface material 1 having excellent appearance can be manufactured. In addition, by fitting the convex portion 20 into the expansion-assisting portion 22, the accuracy of the positioning between the sewing-scheduled portion 11 and the sewing needle 17, that is, the sewing position is improved, and the linearity of the sewing is improved. The swelling of the continuous portion 7 is at a position distant from the sewing needle 17. Therefore, the effect on the holder 16 is minimized. As a result, sewing can be performed at the same level as that of, for example, sewing of genuine leather.

In particular, the continuous portion 7 includes the protrusion shape that protrudes to the first surface portion 5 side on the design surface 2 side and is continuous with the design surface 2 of the first surface portion 5 at the position on the second surface portion 6 side further than the tip 7a of the protrusion, and thus the design is improved. However, when the surface material 1 is placed on the support surface 15 of the sewing machine M and the second surface portion 6 is held against the support surface 15 from the design surface 2 side by the holder 16, a reaction force to the protrusion shape of the continuous portion 7 acts in a spring manner such that curvature is likely to occur toward the sewing-scheduled portion 11 in the second surface portion 6. Regarding this problem, in the present embodiment, the bias by the protrusion shape of the continuous portion 7 can be absorbed by the expansion-assisting portion 22. Therefore, even in the surface material 1 where the continuous portion 7 includes the above-described protrusion shape, the sewing on the sewing-scheduled portion 11 by the sewing machine M is easy.

In addition, the expansion-assisting portion 22 can be easily formed, for example, by injection molding simply by being processed in a shape of a mold of the surface material 1.

As shown in FIG. 4, in the present embodiment, an example where the above-described surface material 1 is used for an interior material 25 is shown. The interior material 25 is configured such that at least a part that is a target to be covered of an interior material body portion 26 as a base material is covered with the surface material 1 for decoration. Examples of the interior material 25 include an automobile interior material provided in, for example, an automobile interior of a vehicle such as an automobile.

The interior material body portion 26 is formed in, for example, an appropriate shape using a rigid synthetic resin. The counterface surface 3 of the surface material 1 that is sewn with the sewing thread 10 is fixed, for example, by bonding to at least a part of a front surface of the interior material body portion 26. The surface material 1 is fixed to the interior material body portion 26 such that at least the sewing thread 10 of the sewing-scheduled portion 11 forms a part of the design of the interior material 25. The interior material body portion 26 includes: a first portion 28 to which the counterface surface 3 of the first surface portion 5 is fixed; and a second portion 29 to which the counterface surface 3 of the second surface portion 6 is fixed. In the first portion 28 and the second portion 29, the front surface covered with the surface material 1 may be formed stepwise, and the second portion 29 may be fixed to the first portion 28 such that the terminal portion of the surface material 1 is folded from a terminal portion of the interior material body portion 26 to a rear surface side of the interior material body portion 26. The expansion-assisting portion 22 is a portion that is not in contact with the front surface of the interior material body portion 26, and substantially has no effect on the design surface 2 side.

This way, the interior material 25 including the above-described surface material 1 has excellent appearance and has a high visual quality similar to, for example, genuine leather although the surface material 1 formed of a synthetic resin is used.

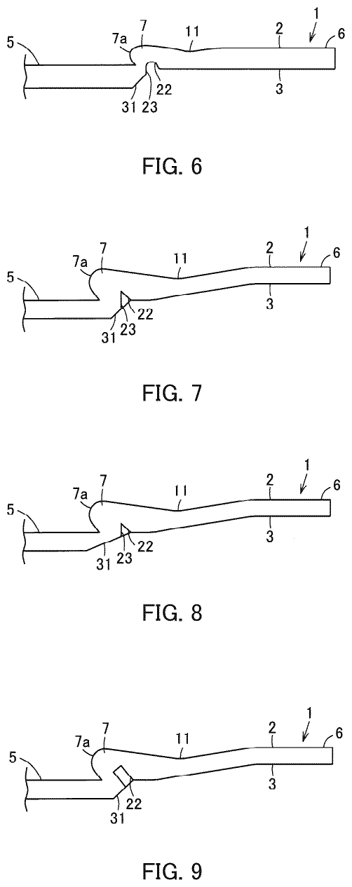

In Embodiment 1, an inclined surface 31 that is continuous with the expansion-assisting portion 22 may be formed on the end surface 23 of the first surface portion 5 as in Embodiment 2 shown in FIG. 6. In this case, when the surface material 1 is placed on the support surface 15 of the sewing machine M and the second surface portion 6 is held against the support surface 15 from the design surface 2 side by the holder 16, the inclined surface 31 also comes into firm contact with the support surface 15. Therefore, the stability of the surface material 1 on the support surface 15 is further improved, and sewing is easier.

Further, a cross-sectional shape of the expansion-assisting portion 22 is not limited to a circular shape. For example, as in Embodiment 3 shown in FIG. 7, a cross-sectional shape of the expansion-assisting portion 22 may be a triangular shape (for example, the tip portion may be a triangular shape having an acute angle). In addition, as in Embodiment 4 shown in FIG. 8, the inclination of the inclined surface 31 may be gentle.

Further, as in Embodiment 5 shown in FIG. 9, a cross-sectional shape of the expansion-assisting portion 22 may be a quadrangular shape (for example, a rectangular shape that is long on a tip side).

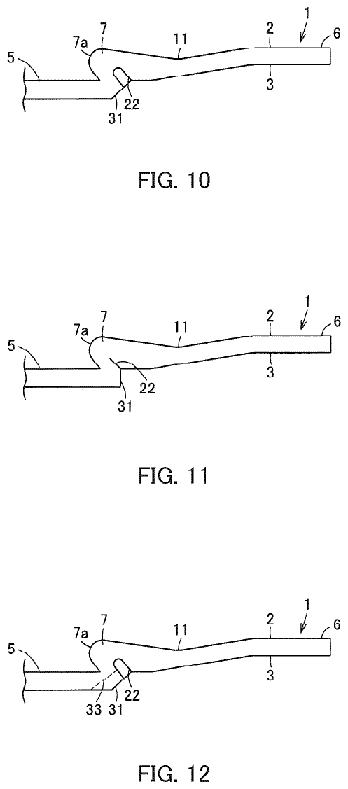

In addition, as in Embodiment 6 shown in FIG. 10, a cross-sectional shape of the expansion-assisting portion 22 may be an elliptical or an elongated shape.

Further, the expansion-assisting portion 22 does not need to be accompanied by hollowing, and may be formed as a simple slit, for example, as in Embodiment 7 shown in FIG. 11.

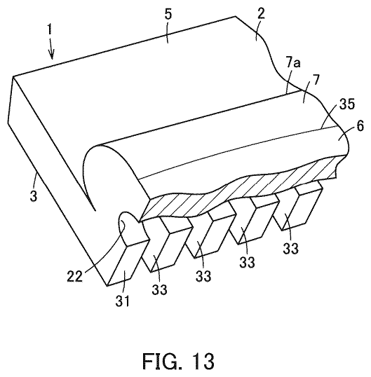

In addition, for example, as in Embodiment 8 shown in FIGS. 12 and 13, the expansion-assisting portion 22 may have a zigzag shape including notch portions 33 that are sequentially formed in a direction along the sewing-scheduled portion 11. In this configuration, the flexibility of the continuous portion 7 can be further improved by the notch portions 33. Therefore, for example, even when a three-dimensional shape 35 where the design surface 2 side of the continuous portion 7 swells along the sewing-scheduled portion 11 is provided, the second surface portion 6 can be stably held in a planar shape irrespective of the steps of the counterface surface 3 between the first surface portion 5 and the second surface portion 6.

Further, in each of the embodiments, the surface material 1 does not need to be used for the interior material 25, and may be used for any other targets to be covered.

### INDUSTRIAL APPLICABILITY

The present invention can be suitably used as a surface material for decorating, for example, an automobile interior material.

### REFERENCE SIGNS LIST

1 Surface material
5 First surface portion
6 Second surface portion
7 Continuous portion
7a Tip
11 Sewing-scheduled portion
22 Expansion-assisting portion
25 Interior material
26 Interior material body portion

What is claimed is:

1. A surface material comprising:
a first surface portion; and
a second surface portion that is continuous with the first surface portion through a continuous portion and where a back surface side is formed stepwise on a front surface side with respect to the first surface portion, wherein
the second surface portion includes a sewing-scheduled portion to be sewn with a sewing thread, and
the continuous portion is provided with an expansion-assisting portion that allows the continuous portion to be expandable from the back surface side, at a position along the sewing-scheduled portion on the back surface side.

2. The surface material according to claim 1, wherein
the continuous portion has a protrusion shape that protrudes to a side of the first surface portion on the front surface side and is continuous with a front surface of the first surface portion at a position on a side of the second surface portion further than a tip of the protrusion.

3. An interior material comprising:
an interior material body portion; and
the surface material according to claim 1 that covers at least a part of the interior material body portion.

4. An interior material comprising:
an interior material body portion; and
the surface material according to claim 2 that covers at least a part of the interior material body portion.
